(19) United States
(12) Patent Application Publication
(10) Pub. No.: US 2013/0112036 A1
(43) Pub. Date: May 9, 2013

(54) Split-Shaft S-Cam

(71) Applicants: Dan Miller, Cashion, OK (US); Steven Craig, Newcastle, OK (US)

(72) Inventors: Dan Miller, Cashion, OK (US); Steven Craig, Newcastle, OK (US)

(21) Appl. No.: 13/289,085

(22) Filed: Nov. 4, 2011

(51) Int. Cl. F16D 65/22; B23P 13/00; F16H 53/00

(52) U.S. Cl. 74/567; 29/401.1

(57) ABSTRACT

A method for manufacturing a split-shaft S-cam and apparatus. The method for converting a one-piece S-cam into a two-piece comprises: cutting an S-cam along a non-bearing-surface portion resulting in an S-cam inner portion and a head portion; machining a coupling means for releasably joining the inner and head portions into each cut end; providing a nipple having, cooperating coupling means for engaging with the coupling means machined into each cut end, and a shoulder having a width equivalent to the material removed in the cutting step, the shoulder disposed between the coupling means and adapted to engage a cooperating shoulder on each of the ends; mating the coupling means with the cooperating coupling means; whereby, the two-piece S-cam allows replacement of at least a portion of an S-cam without requiring complete disassembly of a trailer brake. The coupling means and cooperating coupling means may be threaded, splined, or other well-known mechanical-type connections.

### CROSS-REFERENCE TO RELATED APPLICATIONS

None.

### SUMMARY OF THE INVENTION

The present invention relates to drum brake systems, and more particularly to S-cams for use in such systems. The invention provides for a two-piece S-cam, which can be used in drum brake systems.

Disclosed are both a method for manufacturing a split-shaft S-cam, and the split-shaft S-cam itself. The method for converting a one-piece S-cam into a two-piece S-cam comprises: cutting an S-cam along a non-bearing-surface portion of its length resulting in an S-cam inner portion and a head portion; machining a coupling means for releasably joining the inner and head portions into each of the cut ends; providing a nipple having, cooperating coupling means for engaging with the coupling means machined into each cut end of the S-cam, and a shoulder having a width equivalent to a length of material removed in the cutting step, the shoulder disposed between the cooperating coupling means and adapted to engage a cooperating shoulder on each of the ends; and mating the coupling means with the cooperating coupling means; whereby, a one-piece S-cam is converted into a two-piece S-cam adapted to allow replacement of at least a portion of an S-cam without requiring complete disassembly of a trailer brake. The coupling means and cooperating coupling means may be threaded, splined, or other well-known mechanical-type connections disclosed by the prior art.

The S-cam according to the present invention comprises: an S-cam inner portion having a means for engaging a brake activator and a length of shaft terminating before a bearing-surface portion begins; an S-cam head portion having an S-cam disposed at one end thereof and having at least one bearing surface; and a coupling means for releasably joining the inner and head portions; whereby, either section may be replaced separately and replacement can take place without complete disassembly of a trailer brake. The coupling means and cooperating coupling means may be threaded, splined, or other well-known mechanical-type connections disclosed by the prior art.

There having thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### DESCRIPTION OF THE DRAWINGS

FIG. 1 is a perspective view of a one-piece S-cam being cut to manufacture a split-shaft S-cam.

FIG. 2 is an exploded perspective view of a two-piece S-cam and threaded nipple.

FIG. 3 is a side view of a two-piece S-cam with integral threads.

FIG. 4 is a perspective view of a two-piece S-cam with integral splines.

FIG. 5 is a perspective view of an assembled two-piece S-cam with a nipple in place.

### DETAILED DESCRIPTION OF THE INVENTION

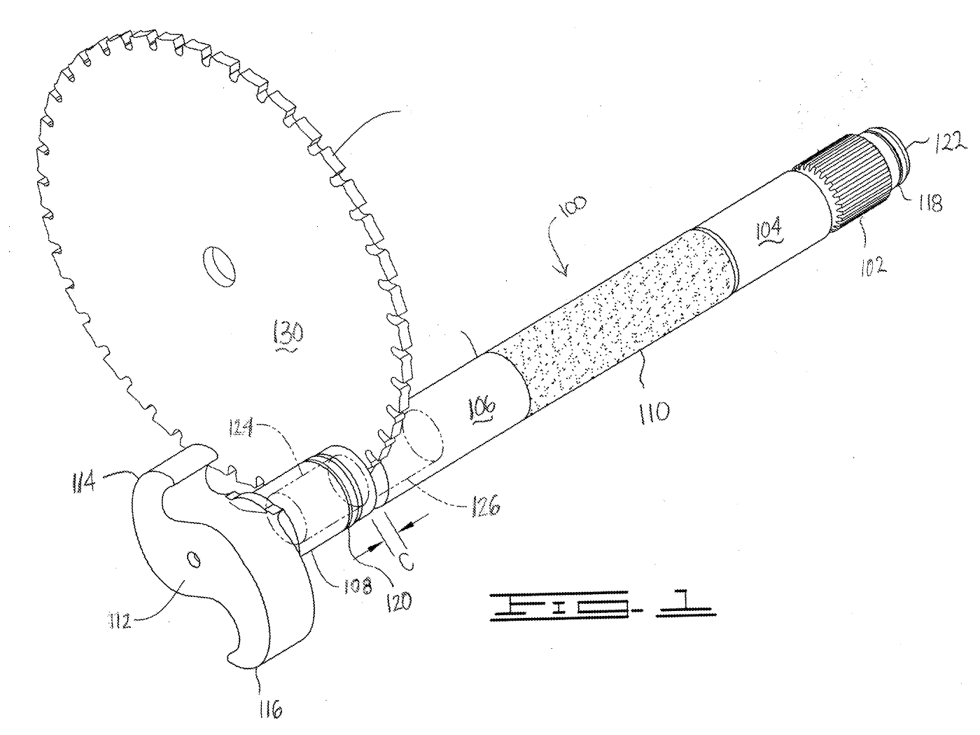

S-cams are well known in the mechanical industry with respect to drum brakes, generally on larger trucks and trailers. The construction of a typical S-Cam is illustrated generally in FIG. 1. FIG. 1 shows the S-Cam 100 having gears 102 at a first end 122 for engaging a brake actuator (not shown). The brake actuator may be operated electronically, by air, hydraulically, or by other means, and the means of operation of the brake actuator is not relevant to the invention.

There will be at least one bearing section along the length of the S-Cam 100, and there are generally two or more. As shown in FIG. 1, a first bearing section 104 nearer the gears 102 can be seen. Thereafter, is an intermediate section 110 which is a non-bearing surface followed by a second bearing section 106 and a third bearing section 108, with the third bearing section 108 being closest to the S-Cam 112.

The S-cam 112 has a first arm 114 and second arm 116 for engaging the drum in a brake. The S-Cam 112 is closer to the wheel, and the gears 102 are disposed away from the wheel along and near the axle.

Also typically defined on an S-Cam 112 is at least one keeper channel. As shown, a first keeper channel 118 is located between the gears 102 and the first end 122. A second keeper channel 120 is shown between the second bearing section 106 and the third bearing section 108. The purpose of the keeper channels 118 and 120 is to receive a keeper (not shown) to hold the S-Cam 112 in place to ensure that it does not move further toward the wheel or away from the wheel than is desired in operation.

FIG. 1 illustrates an operation in which a one-piece S-Cam is cut into two pieces. As shown, a saw blade 130 is cutting the S-cam 100 into two pieces between the second and third bearing sections 106 and 108, respectively. The place where a first threaded receiver 124 will be machined and a second threaded receiver 126 will be machined are shown in FIG. 1 with dashed cylindrical lines. However, when the S-cam 100 is first cut, the pieces are solid. The first and second threaded receivers 124 and 126 are machined into the pieces after they are cut. The saw blade 130 has a width “c,” as shown. This width, “c,” will be matched, as further discussed below, by a shoulder 206 on a nipple 200 to be placed between the two pieces resulting from the cut.

Once the S-Cam has been cut into two pieces, or if it is originally manufactured in two pieces, there needs to be a means for mating the two pieces together in operation which also allows for them to be released for service or to be replaced. As shown, two different configurations for the connections are described: A first threaded connection; and a second splined connection. It is well known in the art to use other methods to releasably connect two metal pieces together. Splines are an option as are threads of various sorts. However, connectors for two pieces in the machining arts an old and well established art and the invention incorporates any of the various methods for joining two metal pieces together that are available in the machine arts.

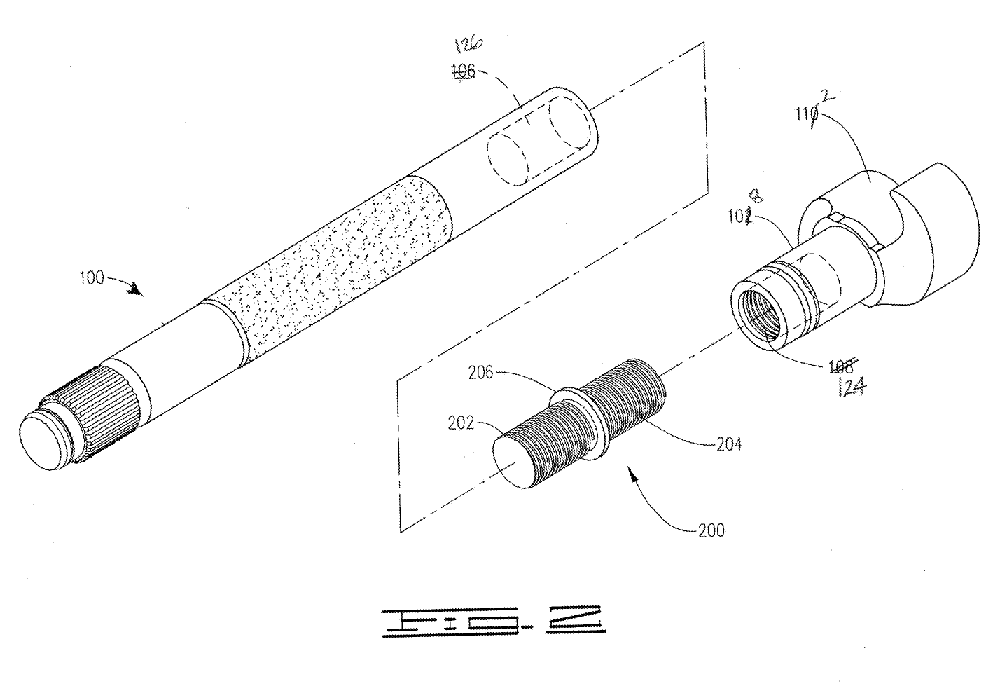

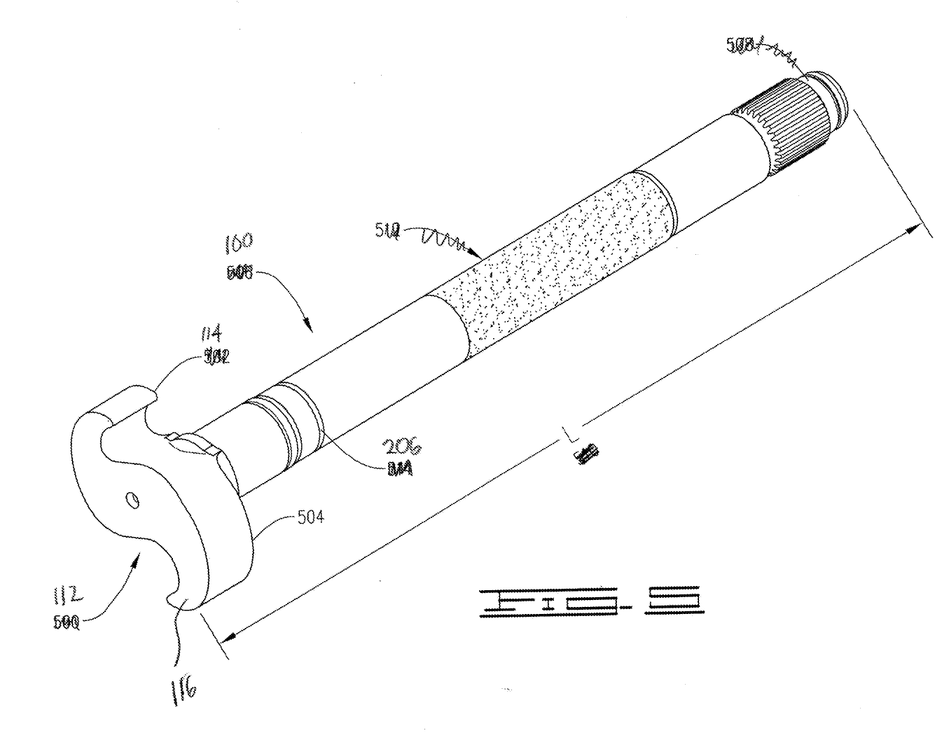

Once a one-piece S-Cam has been cut into two parts, a means for connecting them must be machined. As shown in FIG. 2, the threads can be machined into the two cut ends creating a first threaded receiver 124 and a second threaded receiver 126. These threaded receivers will cooperate with a threaded nipple 200 to join the two parts of the S-Cam together. The nipple 200 has a first threaded end 202 and a second threaded end 204 separated by a shoulder 206. The width of the shoulder will be equivalent to the width of the saw blade “c,” as shown in FIG. 1. Thus, when the two pieces are joined by the threaded nipple 200, the S-Cam will have the same overall length, “l,” as it originally had before being cut. See FIG. 5.

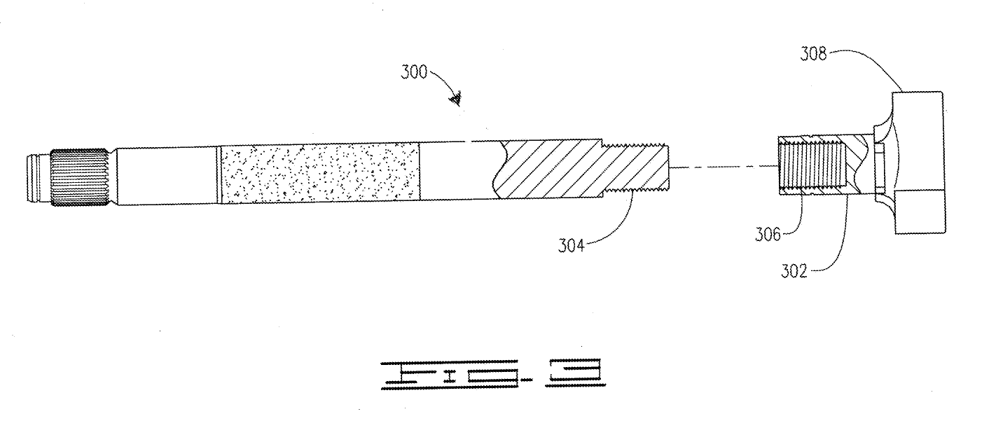

FIG. 3 illustrates a configuration of the S-Cam where the threaded connections are formed at the factory, and the S-Cam is not a one-piece S-cam converted after the fact. Alternatively, the threaded connection shown in FIG. 3 could be used for a converted one-piece

S-Cam if the width of the saw blade cut being removed from the overall S-Cam shaft length is not critical to the operation of the braking system. Shown in FIG. 3, the longer section 300 has defined therein a male thread 304. A female thread 306 is defined in the shorter section 306 near the S-cam 308.

Inherent in the discussion above about threaded sections is the concept that the threads are biased in a way that when the S-Cam operates, the threads are biased in a tightening direction. Thus, if the alternate were true, when the S-Cam operated, the threads would tend to become unscrewed and the S-Cam would be unstable in operation. Therefore, it is key that the threads all be biased in favor of tightening the threads by operation of the S-Cam in the braking system.

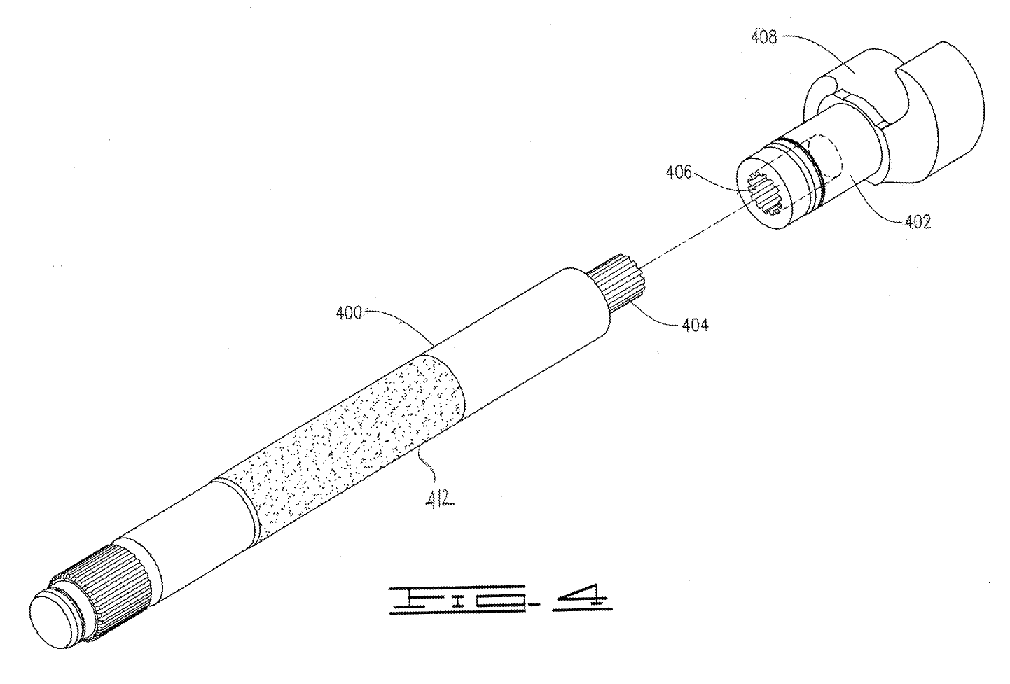

FIG. 4 illustrates the same basic idea as shown in FIG. 3, but in FIG. 4, splines are used instead of threads. The splined split-shaft S-cam 400 has a splined receiver 406 defined in the head portion 412 nearer the S-cam 408 and a male end 404 defined in the inner portion 402. A splined nipple having a first splined end and a second splined end with a shoulder separating the first splined end and a second splined end with the shoulder separating them may be provided instead of the threaded nipple shown in FIG. 2. Again, the shoulder in a splined configuration will have a width, “c,” that is equivalent to the saw blade providing for the same overall length of the S-Cam after the splined nipple is inserted.

FIG. 5 shows an assembled S-cam 100 with the nipple shoulder 206 visible from the outside. The threads or splines or the like on the nipple 200 are not visible in FIG. 5. The overall length “L” shown for the S-cam 100 is the same as before it was cut because the nipple shoulder 206 makes up for the width of the saw blade 130.

The purpose of the abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

While the invention has been shown, illustrated, described and disclosed in terms of specific embodiments or modifications, the scope of the invention should not be deemed to be limited by the precise embodiment or modification therein shown, illustrated, described or disclosed. Such other embodiments or modifications are intended to be reserved especially as they fall within the scope of the claims herein appended.

Having thus described the invention, I claim:

1. A method for converting a one-piece S-cam into a two-piece S-cam comprising:
a. cutting an S-cam along a non-bearing-surface portion of its length resulting in an S-cam inner portion and a head portion;
b. machining a coupling means for releasably joining the inner and head portions into each of the cut ends;
c. providing a nipple having,
i. cooperating coupling means for engaging with the coupling means machined into each cut end of the S-cam, and
ii. a shoulder having a width equivalent to a length of material removed in the cutting step, the shoulder disposed between the cooperating coupling means and adapted to engage a cooperating shoulder on each of the ends; and
d. mating the coupling means with the cooperating coupling means;
whereby, a one-piece S-cam is converted into a two-piece S-cam adapted to allow replacement of at least a portion of an S-cam without requiring complete disassembly of a trailer brake.

2. The S-cam manufactured according to the method of claim 1, the coupling means and cooperating coupling means comprising threaded connections.

3. The S-cam manufactured according to the method of claim 1, the coupling means and cooperating coupling means comprising splined connections.

4. An S-cam comprising:
a. an S-cam inner portion having a means for engaging a brake activator and a length of shaft terminating before a bearing-surface portion begins;
b. an S-cam head portion having an S-cam disposed at one end thereof and having at least one bearing surface; and
c. a coupling means for releasably joining the inner and head portions;
whereby, either section may be replaced separately and replacement can take place without complete disassembly of a trailer brake.

5. The S-cam of claim 4, the coupling means comprising cooperating male-female threads.

6. The S-cam of claim 4, the coupling means comprising cooperating male-female splines.
